(19) United States
(12) Patent Application Publication
(10) Pub. No.: US 2026/0208514 A1
(43) Pub. Date: Jul. 23, 2026

(54) PRINTER

(71) Applicant: Toshiba Tec Kabushiki Kaisha, Tokyo (JP)

(72) Inventor: Tsuyoshi SANADA, Susono Shizuoka (JP)

(21) Appl. No.: 19/358,377

(22) Filed: Oct. 14, 2025

(30) Foreign Application Priority Data
Jan. 22, 2025 (JP) 2025-008822

(51) Int. Cl. B41J 15/04; B41J 15/02; B41J 29/13

(52) U.S. Cl. CPC B41J 15/046; B41J 15/02; B41J 15/042; B41J 29/13

(57) ABSTRACT

A printer includes a housing including surfaces and an opening opposite one of the surfaces, a lid rotatably attached to the housing to close the opening, a printing head configured to print on an unwound portion of a rolled sheet, a roller conveying the unwound portion, a sheet holder holding the sheet and inclined with respect to the one of the surfaces such that one end of the holder corresponding to one end of the sheet in a width direction is closer to the one of the surfaces than the other end of the holder corresponding to the other end of the sheet, and a sheet guide having a surface that contacts the unwound portion when the unwound portion is conveyed. Two sides of the surface corresponding to side edges of the unwound portion have different lengths in a conveyance direction of the unwound portion of the rolled sheet.

### CROSS-REFERENCE TO RELATED APPLICATION(S)

This application is based upon and claims the benefit of priority from Japanese Patent Application No. 2025-008822, filed Jan. 22, 2025, the entire contents of which are incorporated herein by reference.

### FIELD

Embodiments described herein relate generally to a printer.

### BACKGROUND

In a printer that holds a roll of a strip-shaped sheet and pulls the sheet from the sheet roll to perform printing, a retaining member is often provided for holding the sheet roll in the width direction. In contrast to such a general structure, there is a technical idea that the retaining member is made unnecessary by holding the sheet roll in a tilted position.

If the sheet roll is held at an angle, the subsequent paper path is also inclined, and in this case, the size of the printer increases. If the thermal head and the platen roller are not inclined, the inclination of the paper must be eliminated in the paper path to the printing position.

In order to achieve effects such as reducing the number of components, lowering manufacturing costs, and facilitating paper replenishment by holding the sheet roll in an inclined state and thereby eliminating the need for a retaining member, the printer requires a structure capable of correcting the inclination of the paper before it reaches the printing position.

In addition, some printers are configured to change the direction in which printed material is discharged, for example, from upward to forward, by changing the orientation of the housing. In such a printer, a structure for holding the sheet roll in a tilted position also needs to be considered.

### SUMMARY OF THE INVENTION

Embodiments of the present disclosure provide a printer capable of correcting the inclination of a sheet pulled out from a sheet roll held in a tilted position, to a printing position.

A printer comprises: a housing including a plurality of surfaces and an opening that is opposite one of the surfaces; a lid rotatably attached to the housing to close the opening; a printing head configured to print on an unwound portion of a rolled sheet; a roller capable of conveying the unwound portion of the rolled sheet toward a gap between the lid and the housing; a sheet holder capable of holding the rolled sheet and inclined with respect to the one of the surfaces of the housing such that one end of the sheet holder corresponding to one end of the rolled sheet in a width direction is closer to the one of the surfaces of the housing than the other end of the sheet holder corresponding to the other end of the rolled sheet in the width direction; and a sheet guide having a surface that contacts the unwound portion of the rolled sheet when the unwound portion is conveyed. Two sides of the surface corresponding to side edges of the unwound portion have different lengths in a conveyance direction of the unwound portion of the rolled sheet.

### BRIEF DESCRIPTION OF THE DRAWINGS

FIG. 1 is a schematic diagram illustrating a structure of a printer according to a first embodiment.

FIG. 2 is a schematic diagram illustrating the structure of the printer according to the first embodiment.

FIG. 3 is a schematic diagram illustrating the structure of the printer according to the first embodiment.

FIG. 4 is a schematic diagram illustrating the structure of the printer according to the first embodiment.

FIG. 5 is a schematic diagram illustrating the structure of the printer according to the first embodiment.

FIG. 6 is a schematic diagram illustrating a structure of a printer according to a second embodiment.

### DETAILED DESCRIPTION

Hereinafter, embodiments will be described in detail with reference to the drawings. Embodiments of the present disclosure are not limited to the embodiments described below.

### First Embodiment

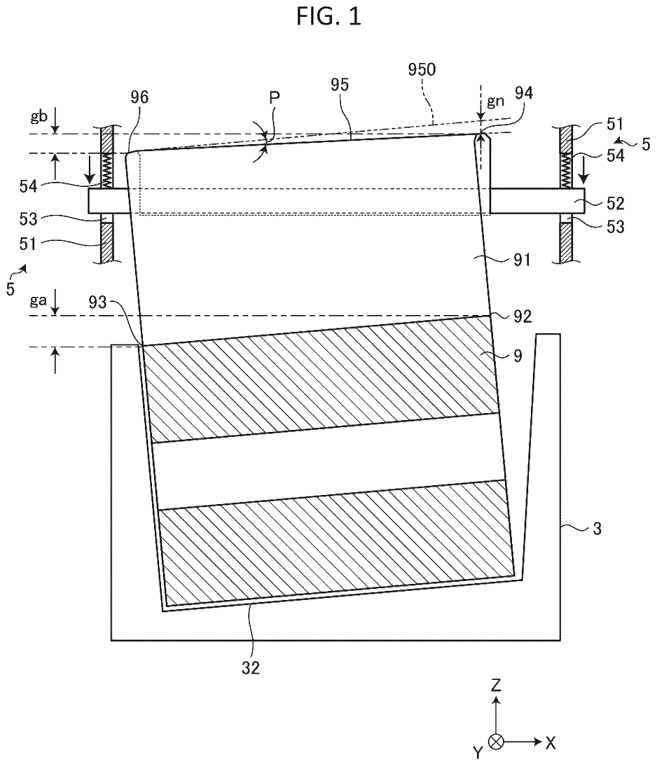

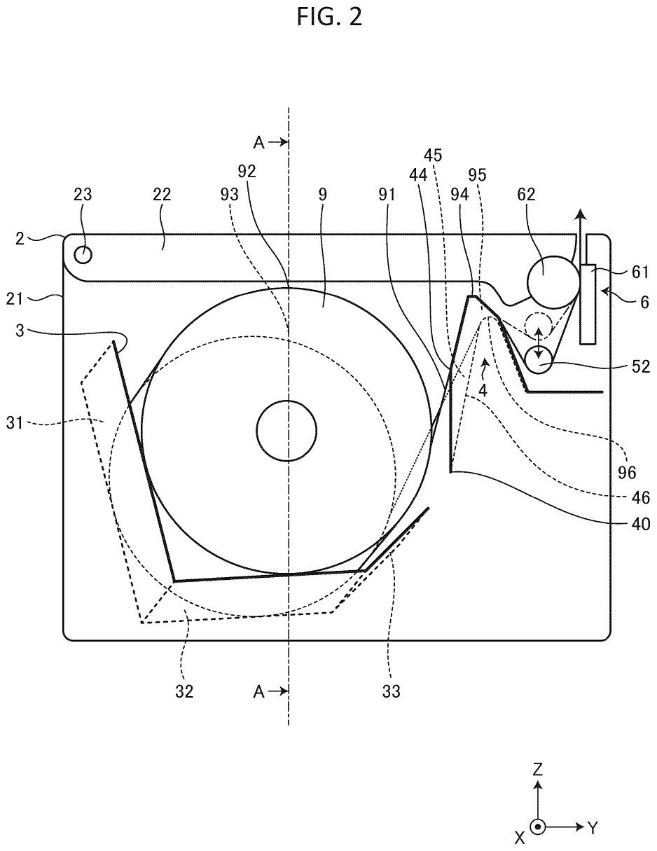

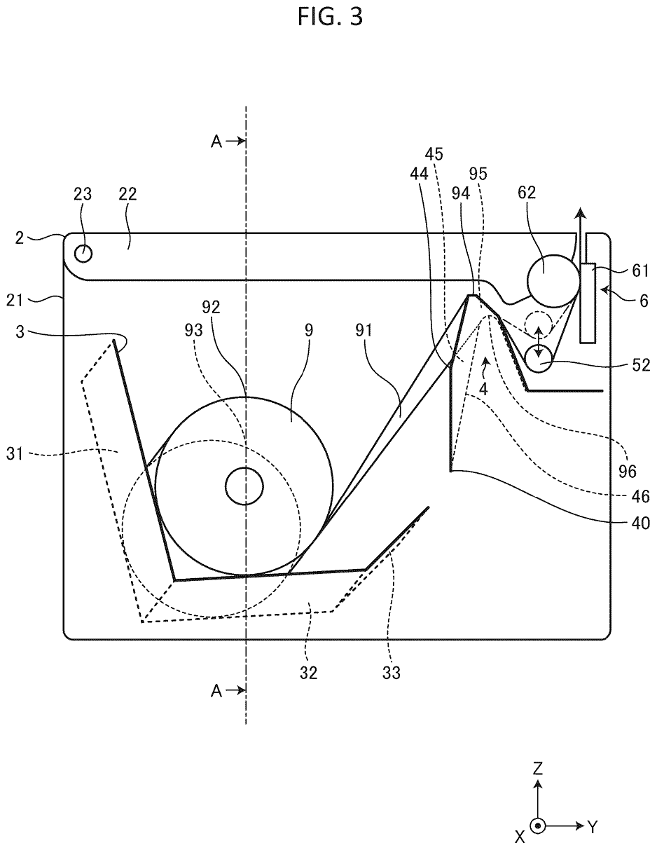

An embodiment will be described with reference to the drawings. FIGS. 1 to 5 are schematic diagrams illustrating an example of a structure of a printer 1 according to a first embodiment. For convenience of explanation, a three dimensional coordinate system is shown in the drawings. The X-axis direction is the width direction (left-right direction) of the printer 1 and the sheet roll 9. The Y-axis direction is the depth direction (front-rear direction) of the printer 1. The Z-axis direction is a height direction (up-down direction) of the printer 1. FIG. 1 is a cross-sectional view taken along line A-A shown in FIGS. 2 and 3.

The depth direction in FIG. 1 is along the depth direction of the printer 1 (Y-axis direction). The right side of the printer 1 is the right side of FIG. 1, and the left side of the printer 1 is the left side of FIG. 1. The positive direction of the X axis is a direction from the left side to the right side.

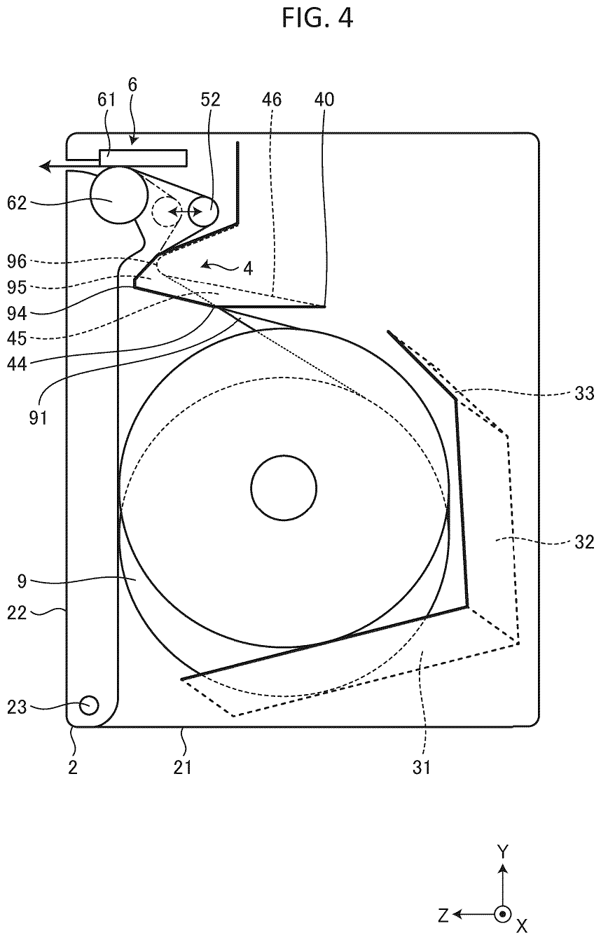

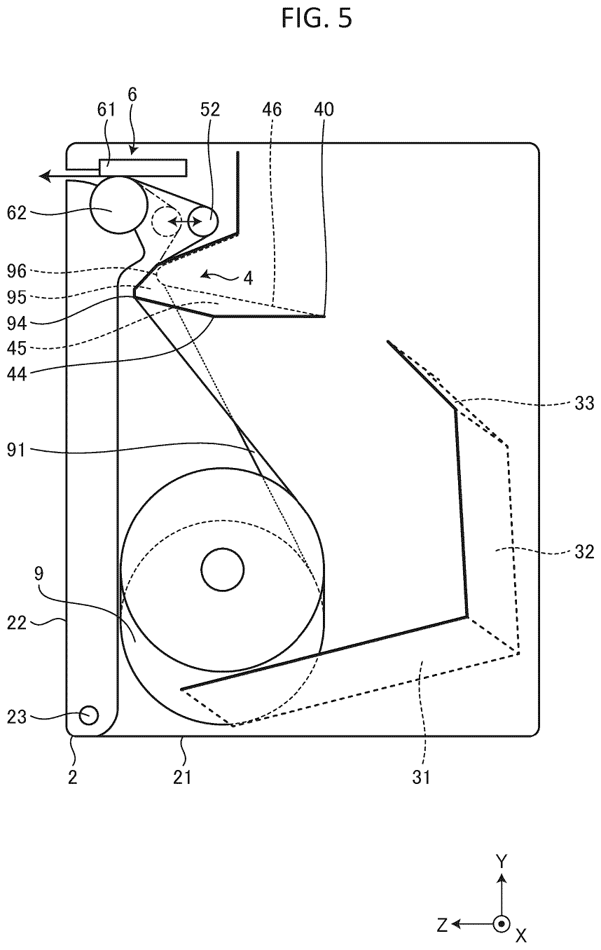

The depth direction in FIGS. 2 to 5 is along the width direction (X-axis direction) of the printer 1 and the sheet roll 9. The installation state of the printer 1 in FIGS. 2 and 3 is an upward sheet ejection state, and the installation state of the printer 1 in FIGS. 4 and 5 is a forward sheet ejection state. Further, the sheet roll 9 in FIGS. 2 and 4 shows an example of a state of the maximum diameter, and the sheet roll 9 in FIGS. 3 and 5 shows an example of a state of the reduced diameter.

In the description of the present embodiment, the front, rear, left, and right of the printer 1 are sometimes indicated, but this is an example for convenience in order to make the description easier to understand, and it goes without saying that the front, rear, left, and right of the printer 1 may be reversed in the implementation.

The printer 1 includes a housing 2, a sheet holder 3, an adjuster 4, a damper 5, a printing unit 6, and the like. The housing 2 is a box-shaped case constituted by a main body 21, a lid 22, and a hinge 23, and houses the above-described respective parts (the sheet holder 3, the adjuster 4, the damper 5, the printing unit 6, and the like).

The main body 21 has a box shape with an opening. The lid 22 is movable between a position where the opening of the main body 21 is closed and a position where the opening of the main body 21 is opened, and opens and closes the opening of the main body 21 as the lid 22 moves. The hinge 23 rotatably connects a part of the lid 22 to a part of the edge of the main body 21. The lid 22 is movable relative to the main body 21 by the rotation, and the opening of the main body 21 is opened and closed by the movement (rotation).

The sheet roll 9 is a roll of a strip-shaped sheet 91. The sheet holder 3 is in a space between the main body 21 and the lid 22, and rotatably holds the sheet roll 9. The sheet roll 9 rotates as the sheet 91 is pulled out. The sheet 91 is conveyed by the printing unit 6 and pulled out to the downstream side in the conveyance direction.

The sheet holder 3 supports the outer peripheral surface of the sheet roll 9 by a surface inclined in a direction in which a distance to the lid 22 is displaced along the width direction of the sheet roll 9 and a direction in which a distance to the printing unit 6 is displaced along the width direction of the sheet roll 9.

The sheet holder 3 is a so-called drop-in type, and has a substantially U-shaped shape of the recess inclined with respect to the width direction (X-axis direction) and the front-rear direction (Y-axis direction) of the printer 1. The sheet roll 9 is dropped into the shape of the recess and held in a tilted position. The sheet roll 9 dropped into the shape of the recess inclined with respect to the width direction of the sheet holder 3 is inclined along the shape of the recess as the outer circumferential surface of the sheet roll 9 itself comes into contact with the inside of the shape of the recess. The sheet roll 9 is inclined in such a manner that the right side in FIG. 1 is high and the left side is low, and the front side in FIGS. 2 and 3 is high and the back side is low. The sheet roll 9 is inclined so that the front side in FIGS. 4 and 5 is higher and the back side is lower. The adjuster 4 is located at a position where the shape of the recess is extended to the downstream side in the sheet conveyance direction.

The recess is formed by a plurality of bottom surfaces 31, 32 and 33. The bottom surfaces 31, 32 and 33 are inclined first with respect to the depth direction of the recess and also inclined with respect to another direction. The other direction is the depth direction of the recess when the opening portion of the shape of the recess is set to forward (that is, when the housing 2 is placed in the state of FIGS. 4 and 5).

Each of the bottom surfaces 31, 32 and 33 is inclined, and the inclination direction thereof is such that the right side in FIG. 1 is high and the left side is low, in other words, the front side in FIGS. 2 and 3 is high and the back side is low. At least the bottom surface 31 of the bottom surfaces 31, 32 and 33 is further inclined in a direction in which the front side in FIGS. 4 and 5 is high and the back side is low.

The printing unit 6 includes a thermal head 61 and a platen roller 62. The thermal head 61 includes a plurality of heating elements arranged linearly along the width direction. The platen roller 62 holds the sheet 91 between the platen roller 62 and the heating element, and rotates to convey the sheet 91. The printing unit 6 prints on the sheet 91 by selectively driving the heating element while conveying the sheet 91.

The damper 5 is a buffer unit that reduces an impact due to a change in the conveying force of the sheet 91 between the sheet holder 3 and the printing unit 6. The damper 5 reduces the conveyance resistance when the sheet roll 9 starts rotating with the conveyance of the sheet 91 between the sheet holder 3 and the printing unit 6. That is, when the force required to convey the sheet 91 is large, the tension of the sheet 91 is loosened.

An example of the structure of the damper 5 is as follows. The damper 5 includes a pair of side walls 51, a rod 52, and a pair of elastic members 54.

The rod 52 is formed by one or more shafts around which the sheet 91 is wound. The rod 52 supports the sheet 91 so that a height difference between the rod 52 and the bottom surface 32 of the sheet holder 3 may be changed at both sides of the sheet 91 in the width direction.

The elastic member 54 is for biasing the rod 52 and is built in the slit 53 formed in the side wall 51. The slit 53 is long in the vertical direction, and the dimension in the short direction is slightly larger than the thickness of the rod 52.

The rod 52 is supported at both ends by the slits 53, is slidable up and down in the slit 53, and is biased downward by the elastic member 54.

With this structure, the rod 52 slides up and down according to the tension of the sheet 91 while slightly allowing rolling about the Y axis and keeping a state substantially parallel to the X axis.

The adjuster 4 (hereinafter also referred to as the sheet guide) guides the sheet 91 from the sheet holder 3 to the damper 5, and adjusts the conveyance path length of the sheet 91 in the specified section. The adjuster 4 adjusts the conveyance path length of the sheet 91 by changing the conveyance path length according to the width direction position of the sheet 91. More specifically, the adjuster 4 adjusts the conveyance path length so that the conveyance path length is longer on the higher side of the sheet roll 9 and shorter on the lower side of the sheet roll 9.

### (Example of Upward Sheet Ejection)

For convenience of explanation, an example of upward sheet ejection (an example in which the printer 1 is used in the orientation shown in FIGS. 2 and 3) will be described first. The difference between the example of the forward sheet ejection (the example in which the printer 1 is used in the arrangement shown in FIGS. 4 and 5) and the example of the upward sheet ejection will be described in detail later.

The adjuster 4 is located between the sheet holder 3 and the damper 5 and protrudes in the upward in height direction. The adjuster 4 bends the conveyance path of the sheet 91 from the sheet holder 3 to the damper 5 into a mountain shape.

The top part of the adjuster 4 is referred to as the bending part, and bends the conveyance path of the sheet 91 between the sheet holder 3 and the damper 5 by a shape protruding in a direction away from the bottom of the sheet holder 3.

More specifically, the top part of the adjuster 4 is a substantially straight line inclined with the left side being low and the right side being high. At the top part of the adjuster 4, the traveling direction of the sheet 91 is bent and changed from upward to downward. The bending part 95 of the sheet 91 is substantially straight along the top part of the adjuster 4.

If the adjuster 4 guides the sheet 91 only by the top part, the top part of the adjuster 4 needs to be inclined in the same manner in accordance with the inclination of the sheet roll 9 in order to prevent a difference in the conveyance path length of the sheet 91 between the left and right sides from the sheet holder 3 to the damper 5. However, in such a structure, the top part of the adjuster 4 is high, and thus the housing 2 is large.

Therefore, in the printer 1 of the present embodiment, the surface of the adjuster 4 before the top part pushes up the sheet 91 so that the conveyance path length of the higher side (right side) of the sheet 91 is longer than the lower side (left side). The details are as follows. The “surface before the top part” is a surface located at a position lower than the top part of the adjuster 4, and corresponds to a slope 45 described below (see FIGS. 2 and 3).

The right edge 44 and the left edge 46 of the contour line of the slope 45 (see FIGS. 2 and 3) have different shapes. Specifically, the left edge 46 is a straight oblique line, whereas the right edge 44 is a curved line that bulges in the negative direction of the Y axis when viewed from the direction along the width direction of the printer 1 (the direction shown in FIGS. 2 and 3). Accordingly, a slope 45 sandwiched between the right edge 44 and the left edge 46 is a curved surface.

The slope 45 is a surface that supports the sheet 91 between the sheet holder 3 and the bending part 95 (the top part of the adjuster 4), and is also referred to as the support portion in which the higher side of the sheet roll 9 protrudes more than the lower side.

By guiding the sheet 91 by the slope 45, the length of the sheet 91 from the sheet roll 9 to the top part of the adjuster 4 can be made different between the right and left sides, and the right side can be made longer and the left side can be made shorter.

With the above-described structure, a height difference gb between the right edge 94 and the left edge 96 of the sheet 91 in the top part of the adjuster 4 can be made smaller than a height difference ga between the right edge 92 and the left edge 93 of the sheet roll 9.

In FIG. 1, a two dot chain line 950 positioned at the top part of the adjuster 4 reflects the inclination of the sheet roll 9. The bending part 95 of the sheet 91 has a slope reduced by an angle P from that of the two dot chain line 950. A height difference gn between the right edge 94 of the sheet 91 and the two dot chain line 950 in the top part of the adjuster 4 is equal to the difference between the height difference ga and the height difference gb.

Here, the sheet holder 3 has the lowest corner between the bottom surface 31 and the bottom surface 32. Therefore, when the diameter of the sheet roll 9 becomes small as shown in FIG. 3, the sheet roll 9 moves in the negative direction of the Y axis. In this state, the conveyance path of the sheet 91 is separated from the slope 45 of the adjuster 4, and thus the adjustment of the conveyance path length of the sheet 91 by the slope 45 may not be sufficiently effective. However, in a state where the diameter of the sheet roll 9 is reduced as the sheet 91 is separated from the slope 45, the weight of the sheet roll 9 is also reduced, and thus, even if the adjustment of the left and right path lengths is not sufficient, the adjustment can be absorbed by the movement of the rod 52 of the damper 5.

### (Example of Forward Sheet Ejection)

Next, the case of forward sheet ejection will be described with reference to FIGS. 4 and 5, referring to the differences from the example of upward sheet ejection.

In the forward sheet ejection, the sheet roll 9 is stably positioned so that the outer peripheral surface thereof is supported by the bottom surface 31 and the lid 22. Therefore, the inclination direction of the sheet roll 9 is two directions in the upward sheet ejection, but is one direction in the forward sheet ejection. Therefore, the amount of inclination of the sheet roll 9 with respect to the width direction of the printer 1 is considered to be smaller than that in the case of the upward sheet ejection.

As the diameter of the sheet roll 9 decreases, the conveyance path of the sheet 91 moves away from the slope 45. In the case of the forward sheet ejection, the slope 45 is located above the sheet roll 9, and thus the sheet 91 is separated from the slope 45 earlier than in the case of the upward sheet ejection.

Therefore, in the case of the forward sheet ejection, even if the amount of inclination of the sheet roll 9 is smaller than that in the case of the upward sheet ejection, there is no inconvenience that the adjustment of the left and right path lengths of the sheet 91 by the adjuster 4 is too effective. Therefore, according to the present embodiment, it is possible to realize appropriate path length adjustment.

As described above, according to the first embodiment, in the printer 1 configured to be able to selectively change the installation state between the placement corresponding to the upward sheet ejection and the placement corresponding to the forward sheet ejection, the sheet roll 9 can be held in a tilted position in either placement. Further, it is possible to provide the printer 1 capable of correcting the inclination of the sheet 91 pulled out from the sheet roll 9 held in a tilted position to the printing position.

The above-described embodiment can be modified and implemented as appropriate by changing a part of the configuration or the function of each of the above-described devices. Next, a modification of the above-described embodiment will be described as another embodiment. In the description, points different from the above-described embodiment will be mainly described, and the same reference numerals are used for points common to the contents already described, and detailed description thereof will be omitted. The embodiments may be implemented individually or in combination as appropriate.

### Second Embodiment

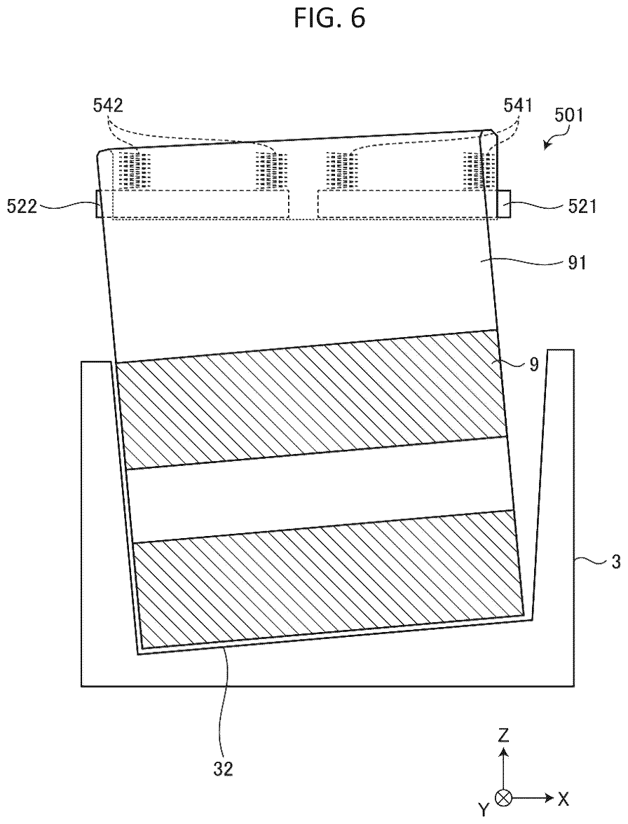

FIG. 6 is a schematic diagram illustrating a structure of a printer 1 according to a second embodiment. In the present embodiment, a damper 501 is provided instead of the damper 5 in the first embodiment.

The damper 501 includes a pair of rods 521 and 522, a biasing member 541 that biases the rod 521 downward, and a biasing member 542 that biases the rod 522 downward.

According to such a configuration, the rod 521 and the rod 522 can be moved individually.

When the rods 521 and 522 pressing the sheet 91 are separated into the left and right, compensation for the adjustment of the path length of the sheet 91 on the left and right sides is easily performed, and thus the degree of freedom of the adjustment of the path length of the sheet 91 on the left and right sides by the slope 45 can be increased.

While certain embodiments have been described, these embodiments have been presented by way of example only, and are not intended to limit the scope of the disclosure. Indeed, the novel embodiments described herein may be embodied in a variety of other forms; furthermore, various omissions, substitutions and changes in the form of the embodiments described herein may be made without departing from the spirit of the disclosure. The accompanying claims and their equivalents are intended to cover such forms or modifications as would fall within the scope and spirit of the disclosure.

What is claimed is:

1. A printer comprising:
a housing including a plurality of surfaces and an opening that is opposite one of the surfaces;
a lid rotatably attached to the housing to close the opening;
a printing head configured to print on an unwound portion of a rolled sheet;
a roller capable of conveying the unwound portion of the rolled sheet toward a gap between the lid and the housing; and
a sheet holder capable of holding the rolled sheet and inclined in a first direction with respect to a surface of the lid that is closed and in a second direction with respect to the printing head, wherein
when the unwound portion of the rolled sheet is ejected through the gap in a first ejection direction, the sheet holder holds the rolled sheet to be inclined in the first and second directions, and
when the unwound portion of the rolled sheet is ejected through the gap in a second ejection direction that is perpendicular to the first ejection direction, the sheet holder holds the rolled sheet to be inclined in the second direction.

2. The printer according to claim 1, further comprising:
a sheet guide having a surface that contacts the unwound portion of the rolled sheet when the unwound portion is conveyed, wherein two sides of the surface corresponding to side edges of the unwound portion have different lengths in a conveyance direction of the unwound portion of the rolled sheet.

3. The printer according to claim 2, wherein
a conveyance path of one of the side edges of the unwound portion of the rolled sheet is longer than a conveyance path of the other side edge of the unwound portion.

4. The printer according to claim 2, further comprising:
a damper capable of easing a tension of the unwound portion of the rolled sheet when contacting the unwound portion.

5. The printer according to claim 4, wherein
the damper includes:
a shaft that contacts the unwound portion of the rolled sheet, and
a biasing member that biases the shaft.

6. The printer according to claim 5, wherein
the shaft is movable while contacting the unwound portion.

7. The printer according to claim 5, wherein
the damper includes a pair of side walls, each having a slit in which the shaft is slidably supported.

8. The printer according to claim 5, wherein
the shaft includes a pair of rods that are individually movable.

9. The printer according to claim 2, wherein
the sheet guide bends the unwound portion of the rolled sheet into a mountain shape.

10. The printer according to claim 2, wherein
the sheet guide includes a top part that is a substantially straight line extending in a first direction and inclined such that one end of the top part in the first direction is closer to the one of the surfaces of the housing than the other end of the top part.

11. The printer according to claim 2, wherein
the surface of the sheet guide includes a first portion including one of the two sides and a second portion including the other side, and the first and second portions have different shapes.

12. The printer according to claim 11, wherein
the first portion has a straight line shape, and
the second portion has a curved line shape.

13. The printer according to claim 2, wherein
a height difference between the side edges of the unwound portion of the rolled sheet at the sheet guide is smaller than a height difference between the side edges of the rolled sheet at the sheet holder.

14. The printer according to claim 1, wherein
the sheet holder is a drop-in type holder with a substantially U-shaped recess.

15. The printer according to claim 14, wherein
the sheet holder includes a plurality of surfaces that form the recess.

16. The printer according to claim 1, wherein
the sheet holder includes first, second, and third surfaces that are connected in this order,
when the housing is placed such that the closed lid faces upward, the first and second surfaces contact the rolled sheet, and
when the housing is placed such that the closed lid faces forward, the lid and the first surface contact the rolled sheet.

17. The printer according to claim 16, wherein
the second surface of the sheet holder faces the closed lid.

18. The printer according to claim 17, wherein
the second surface is not parallel to the lid.

19. The printer according to claim 16, wherein
the first and second surfaces form a first angle,
the second and third surfaces form a second angle that is grater than the first angle.

20. The printer according to claim 16, wherein
an area of the first surface is greater than an area of each of the second and third surfaces.
